(19) United States
(12) Patent Application Publication
(10) Pub. No.: US 2003/0196913 A1
(43) Pub. Date: Oct. 23, 2003

(54) Method of measuring methanol concentration in an arqueous solution

(76) Inventors: Tuyu Xie, Kingston (CA); Daniel Chartouni, Baden (CH); Christian Ohler, Baden (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/126,021

(22) Filed: Apr. 19, 2002

(51) Int. Cl. G01N 27/406

(52) U.S. Cl. 205/787; 204/421; 204/426

(57) ABSTRACT

A method is disclosed for measuring the concentration of a low molecular weight alcohol, such as methanol, in an aqueous solution. The method uses a fuel cell sensor that includes an anode chamber for electrochemical oxidation of the methanol, a cathode chamber for electrochemical reduction of oxygen; a proton conducting membrane arranged between the anode and cathode; and a voltmeter operatively connected to the anode and cathode chambers. An aqueous solution of the methanol is fed to the anode chamber while the fuel cell sensor is operated at an open circuit state, thereby allowing the methanol to crossover to the cathode where it is oxidized. The open circuit voltage across the anode and the cathode is measured using the voltmeter and the concentration of the methanol is determined from the open circuit voltage.

### FIELD OF THE INVENTION

The present invention relates to a method of measuring methanol concentration in an aqueous solution, and more particularly to methods and apparatus for monitoring methanol concentration in a direct methanol fuel cell system.

### BACKGROUND OF THE INVENTION

A fuel cell is a galvanic cell that generates electrical energy by converting chemical energy, derived from a fuel supplied to the cell, directly into electrical energy by an electrochemical process in which the fuel is oxidized in the cell. A typical fuel cell includes an anode, a cathode, electrocatalysts and an electrolyte housed in a casing. The fuel material and oxidant are continuously and independently supplied to the anodes and cathodes, respectively, where the fuel and oxidant react electrochemically to generate a useable electric energy. The reaction by-products are withdrawn from the cell.

A great advantage of a fuel cell is that it converts chemical energy directly to electrical energy without the necessity of undergoing any intermediate steps, for example, combustion of a hydrocarbon or carbonaceous fuel as takes place in a thermal power station. A fuel cell reactor may comprise a single-cell, or a multi-cell stack. In either case, the membrane/electrode assembly (MEA), comprising the proton-conducting membrane (the electrolyte), the anode and cathode catalyst layers, and gas diffusion layers, is typically sandwiched between two highly electrically conductive flow field plates.

Multi-cell stacks comprise two or more such fuel cell assemblies connected together in series to increase the overall power output of the fuel cell as required. In such arrangements, the cells are electrically connected in series, wherein one side of a given flow field plate is the anode plate for one cell, and the other side of the plate is the cathode plate for the adjacent cell and so on.

Solid polymer electrolyte fuel cells employ a membrane electrode assembly (MEA) comprising a solid polymer electrolyte disposed between two porous electrically and ionically conductive electrode layers. The anode and cathode chambers include catalysts to promote the desirable electrochemical reactions. Fuel is fed into the anode chamber, diffusing onto the porous catalyst layer, and is oxidized to produce electrons and protons. The protons migrate through the proton conductive membrane towards the cathode. Oxidant, at the same time, is fed to the cathode chamber. The oxidant diffuses onto the porous cathode catalyst layer and reacts with the protons and electrons, producing water as a by-product. The electrons travel from the anode to the cathode through an external circuit, thus producing the desired electrical power.

A direct methanol fuel cell (DMFC) is a solid polymer electrolyte fuel cell that uses an aqueous methanol solution as the fuel fed to the anode chamber. The methanol concentration fed to the fuel cell is important for keeping a predetermined power output from the fuel cell. A consequence of a DMFC, however, is that both the methanol and water will migrate from the anode to the cathode through the solid proton conductive membrane. This methanol and water migration, referred to as “crossover” is problematic in DMFC operation. Methanol crossover reduces fuel cell performance dramatically. Therefore, only dilute aqueous methanol solutions are used for a normal DMFC operation. When the methanol concentration is too low, the output of the DMFC is limited by methanol diffusion. When the methanol concentration is too high, the output of the DMFC is limited by methanol crossover. Thus, the methanol concentration in the aqueous solution needs to be monitored online and controlled at desired levels during operation of the DMFC.

Methanol concentration can be measured conventionally using a gas chromatograph or a high accuracy density meter. However, these instruments are very expensive and too bulky to be used in a commercial DMFC system. U.S. Pat. No. 6,306,285 discloses a methanol sensor based on methanol oxidation at the anode by measuring limited currents. The sensor only works when the fuel supply is limited by diffusion. Therefore, for relatively high methanol concentration, this sensor must be operated at high current densities. Furthermore, hydrogen is generated at the cathode as a by-product.

Recently, Kunimatsu et al, Fuel Cell Power For Transportation 2001, SWIFT packaging-1589, 31-36 (2001) developed a non-dispersive infrared method based on the difference in the infrared ray permeability of water and methanol. Although the method demonstrated sensitivity to dilute methanol concentration, the device itself is a complicated system.

A number of patents disclose the relationship between methanol concentration and the current generated by a fuel cell. They measure current at a given cell voltage and temperature to determine methanol concentration. An example of this is found in U.S. Pat. No. 4,629,664, where the methanol sensor is a fuel cell comprising an anode electrode, a cathode electrode, a power source, and a detector. With such a structure, when a DC voltage of for example 0.85 V is applied to between the anode and the cathode, the quantity of electric current changes proportionally to the methanol concentration in the anolyte. Thus, it is possible to determine the concentration of methanol by measuring the current generated by the fuel cell. FIG. 12 of this patent illustrates the relationship of current to methanol concentration.

A similar disclosure is made in U.S. Pat. No. 5,773,162 issued to the California Institute of Technology. This patent provides that a constant voltage is applied to the fuel cell by a constant voltage circuit. An ammeter measures the current, which is said to be dependent on the methanol concentration in the solution. A controller, which can be a process controller or a microprocessor, looks up the closest methanol concentration corresponding to the measured current using a plot of the relationship between current and methanol concentration.

These patents measure current and therefore a separate source of power must be applied to the fuel cell.

U.S. Pat. No. 4,810,597 (issued to Hitachi) and U.S. Pat. No. 5,624,538 (issued to Siemens) all disclose measuring voltage to determine the methanol concentration. The Siemens patent measures voltage across a resistor, and describes the sensor as a “quasi direct-alcohol fuel cell”. The sensor includes a polymer electrolyte, in front of whose anode a membrane is arranged, which limits the transport of alcohol. The anode has a catalyst for the electrochemical oxidation of the alcohol; and the cathode has a catalyst for the electrochemical reduction of oxygen. The cathode allows the conversion of atmospheric oxygen to permit operation of the measuring device with air.

This measuring device delivers a signal that is dependent upon the methanol concentration. The measuring device is loaded with a constant resistance and the cell voltage is used as the measuring signal.

The Hitachi U.S. Pat. No. 4,810,597 discloses a device for measuring methanol concentration by measuring the open circuit voltage across the device. The Hitachi patent teaches that the device is a fuel cell comprising an anode, a cathode and an ion exchange membrane that contains an electrolyte such as sulfuric acid. An electrolyte in the fuel is required in addition to the ion exchange membrane. Because these fuel cells use an acidic electrolyte, such as sulfuric acid, such an electrolyte is very aggressive, especially at elevated temperatures, so that only relatively expensive materials can be used to construct these fuel cells. With such an arrangement for the fuel cell, the Hitachi patent discloses that at the operating temperatures of 50° to 60° C., the open-circuit voltage of the cell is dependent on the methanol concentration as shown in FIG. 4 of that patent.

The disclosures of all patents/applications referenced herein are incorporated herein by reference. Therefore, a simple and reliable methanol sensor for a DMFC system has not been reported prior to the present invention. In this invention, a simple and reliable method of measuring methanol concentration is provided for online monitoring of methanol concentration in a DMFC system operation.

### SUMMARY OF THE INVENTION

In a DMFC operation, methanol crossover from the anode to the cathode is undesirable during normal fuel cell operation because methanol crossover will reduce fuel cell power output. Therefore, methanol crossover should be reduced for normal DMFC operations.

Despite the undesirability of methanol crossover, the present invention takes advantage of this phenomenon. The present invention provides a method of measuring methanol concentration using this methanol crossover phenomenon. At open circuit state, the methanol crossover rate is dependent on the concentration of methanol in the aqueous solution present at the anode. The higher the methanol concentration at the anode, the higher the methanol crossover rate. In turn, methanol crossover reduces the voltage of the fuel cell at an open circuit state so that the higher the methanol crossover rate, the lower the open circuit voltage. Therefore, by measuring open circuit voltage, one can determine methanol concentration in the aqueous solution at the anode.

In accordance with one aspect of the present invention, there is provided a method of measuring a concentration of a low molecular weight alcohol in an aqueous solution, the method comprising the steps of:

(a) providing a fuel cell sensor comprising:

i. an anode chamber for electrochemical oxidation of the alcohol comprising an anode flow field plate, an anode gas diffusion layer and an anode catalyst layer;

ii. a cathode chamber for electrochemical reduction of oxygen comprising a cathode flow field plate, a cathode gas diffusion layer and a cathode catalyst layer;

iii. a proton conducting membrane arranged between the anode and cathode chamber; and

iv. a voltmeter operatively connected to the anode and cathode;

(b) feeding the aqueous solution to the anode chamber and feeding air to the cathode chamber;

(c) operating the fuel cell sensor at an open circuit state;

(d) measuring the open circuit voltage across the anode and the cathode using the voltmeter; and

(e) determining the concentration of the low molecular weight alcohol using the open circuit voltage.

The method may also include the further steps of adding a high concentration solution of the low molecular weight alcohol to the aqueous solution when the concentration of the low molecular weight alcohol at the anode chamber is below a predetermined minimum level, or adding water to the aqueous solution when the concentration of the low molecular weight alcohol at the anode is above a predetermined maximum level.

Preferably, the low molecular weight alcohol is methanol and the concentration of methanol in the aqueous solution is maintained in a range from about 0.1 to about 25 weight %, preferably from about 0.5 to about 15 weight %, and most preferably from about 0.5 to about 10 weight %.

In a second aspect, a device is provided for measuring a concentration of a low molecular weight alcohol in an aqueous solution, the device comprising:

(a) an anode chamber for electrochemical oxidation of the low molecular weight alcohol comprising an anode flow field plate, an anode gas diffusion layer and an anode catalyst layer;

(b) a cathode chamber for electrochemical reduction of oxygen comprising a cathode flow field plate, a cathode gas diffusion layer and a cathode catalyst layer;

(c) a proton conducting membrane arranged between the anode and the cathode chamber;

(d) a voltmeter operatively connected to the anode and the cathode to measure voltage across the anode and the cathode; and

(e) an inlet for feeding the aqueous solution to the at least one anode and an inlet for feeding air to the at least one cathode such that an open circuit voltage is generated across the one anode and the one cathode due to oxidation at the cathode of crossover low molecular weight alcohol;

whereby the open circuit voltage is measured by the voltmeter and is dependent on the concentration of the low molecular weight alcohol in the aqueous solution.

The device may further include a first pump for adding a high concentration solution of the low molecular weight alcohol to the aqueous solution when the concentration of the low molecular weight alcohol at the anode is below a predetermined minimum level and a second pump for adding water to the aqueous solution when the concentration of the low molecular weight alcohol at the anode is above a predetermined maximum level.

### BRIEF DESCRIPTION OF THE DRAWINGS

The preferred embodiments of the present invention will be described with reference to the accompanying drawings in which like numerals refer to the same parts in the several views and in which:

FIG. 1 is a schematic diagram of a direct methanol fuel cell (DMFC) stack system with a methanol concentration measurement sensor.

FIG. 2 is a schematic diagram of a DMFC single cell as a sensor.

FIG. 3 is a plot showing open circuit voltage as a function of time at different methanol concentrations at 80° C.

FIG. 4 is a plot showing open circuit voltage as a function of time at different methanol concentrations at 80° C.

FIG. 5 is a plot showing methanol concentration versus open circuit voltage at 80° C.

FIG. 6 is a plot showing methanol concentration versus open circuit voltage at 70° C.

FIG. 7 is a plot showing methanol concentration versus open circuit voltage at 60° C.

FIG. 8 is a plot showing methanol concentration versus open circuit voltage at 50° C.

### DETAILED DESCRIPTION OF THE PREFERRED EMBODIMENTS

The preferred embodiments of the present invention will now be described with reference to the accompanying figures.

In a DMFC, an aqueous methanol solution is directly used as the fuel. The methanol solution is fed to the anode side of the cell, while air is introduced at the cathode. It has been found that when the fuel cell is operated at an open circuit state, that is, the fuel cell is not connected to any external circuit, the methanol concentration in the aqueous methanol solution fed to the anode is related to the open circuit voltage. The methanol introduced at the anode will diffuse (crossover) through the proton conducting membrane to the cathode. Because the fuel cell is at an open circuit state, there is no electrochemical reaction taking place at the anode (at an electrothermodynamic equilibrium state). However, the methanol diffused from the anode will be oxidized at the cathode by oxygen in the air stream fed to the cathode chamber.

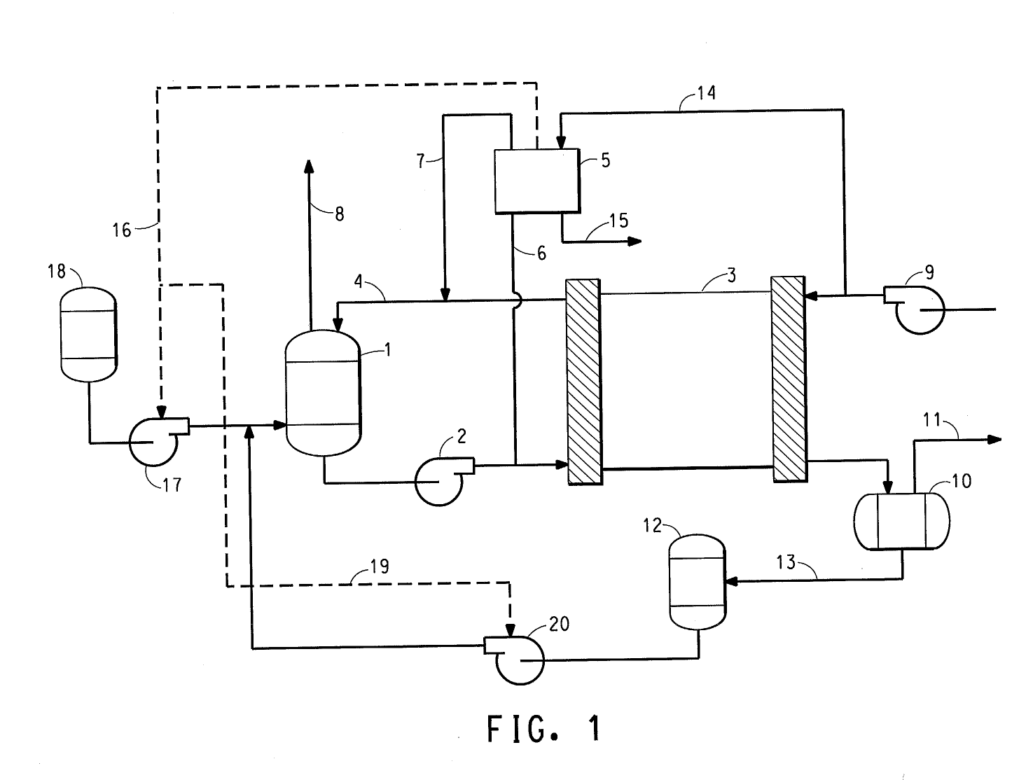

FIG. 1 shows, in a schematic way, a DMFC system. A dilute aqueous methanol solution in reservoir 1 is pumped through a pump 2 into the anode chamber of the DMFC stack 3. Unreacted aqueous methanol solution is recycled back to reservoir 1 through tubing 4. A small portion of the aqueous methanol solution is fed into the sensor fuel cell through tubing 6. Unreacted solution from the sensor fuel cell is recycled back into the recycle tubing 4 through tubing 7. The byproduct, carbon dioxide, is vented through tuning 8 to a residual methanol recovery device (not shown). At the same time, air is pumped through pump 9 into the cathode side of the fuel cell stack. Residual air and by-product water flow into a condenser 10. The residual air is vented through tubing 11 and water is recycled back to a water reservoir 12 through tubing 13. A small portion of air from pump 9 flows into the cathode chamber of the sensor fuel cell through tubing 14 and the residual air is vented through tubing 15.

When the methanol concentration in the solution in reservoir 1 is low, the sensor fuel cell system will send a signal 16 to first pump 17 to add high concentration methanol to reservoir 1 from methanol reservoir 18 until the desired concentration is reached. If the methanol concentration in the solution in reservoir 1 is too high, the sensor signal 19 will start second pump 20 to add water into reservoir 1 until the desired concentration is reached.

In a preferred embodiment, the concentration of methanol in the DMFC is the range of 0.1 to 21 weight %, more preferably 0.5 to 15 weight %, and most preferably 0.5 to 10 weight %.

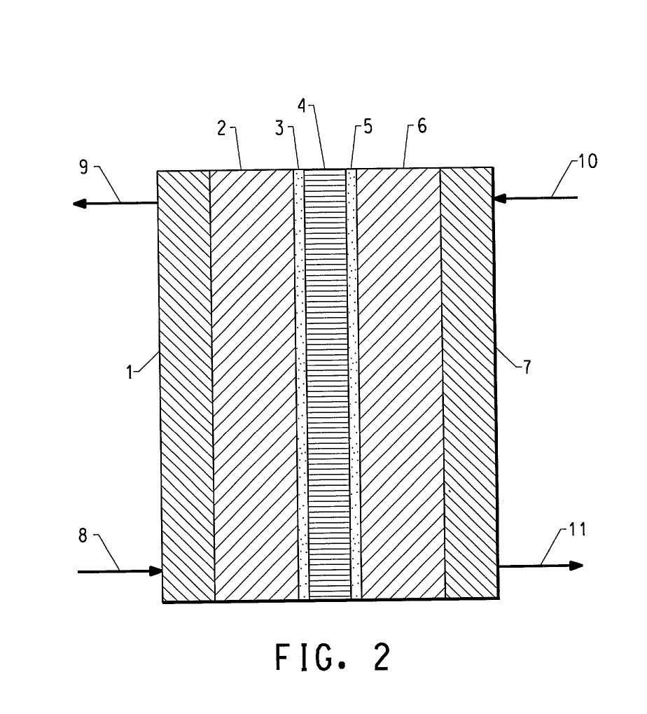

FIG. 2 shows schematically a single fuel cell that can be used as a methanol sensor in accordance with the preferred method of the present invention. The fuel cell sensor includes an anode flow field plate 1 with flow channels (not shown), a diffusion layer 2, an anode catalyst layer 3, a proton conducting membrane 4, a cathode catalyst layer 5, a cathode diffusion layer 6, and a cathode flow field plate 7 with flow channels (not shown).

A dilute aqueous methanol solution is fed into the anode chamber of the fuel cell sensor through inlet port 8, and the residual solution flows out from the outlet 9. The oxidant, air, is fed into the cathode chamber through the inlet 10 and residual oxidant together with water flows out through outlet 11. The fuel cell sensor is operated at an open circuit state and the open circuit voltage is measured by a voltmeter (not shown).

It will be understood that the fuel cell sensor can comprise a single fuel cell as illustrated in FIG. 2, or it can comprise a series of fuel cells connected in series or in parallel.

Thus, in a first preferred embodiment, the fuel cell sensor has a membrane electrode assembly between two conductive flow field plates. The conductive flow field plates serve as mechanical support for the sensor element, as suppliers of reactants and also act as current collectors. Preferably, these conductive flow field plates are made of graphite. Other materials such as graphite-bonded resins, conductive or metallized plastics, coated-metals, e.g. titanium with platinum, gold or titanium nitride, noble metal coated stainless steel, such as stainless steel-coated with gold or platinum, can also be used. Several membrane electrode assembly fabrication methods exist. The membrane electrode assembly can be fabricated using methods disclosed in U.S. Pat. Nos. 5,599,638, 5,773,162, and 5,945,231, the disclosure of which are incorporated herein by reference.

A solid electrolyte membrane, preferably made of NAFION® available from DuPont, is preferably coated with a platinum-ruthenium catalyst layer on the anode side and a platinum catalyst layer on the cathode side. Catalysts can be unsupported or supported on carbon particles (NAFION® or other proton conducting materials are included in the catalyst layer). Two sheets of porous electrode backing substrate (gas diffusion layers), preferably porous carbon paper, are pressed onto the coated membrane, one on either side, forming a membrane electrode assembly. The gas diffusion layers can be untreated carbon paper or cloth, treated carbon paper or cloth using various polymers such as PTFE.

The present invention is further illustrated by the following examples.

### EXAMPLES

### Example 1

A fuel cell sensor used for methanol concentration measurement included an anode electrode with an active area of 100 cm². The anode catalyst layer was a mixture of Pt/Ru alloy and NAFION®. A Pt and NAFION® mixture was used as the cathode catalyst layer. DuPont NAFION® 117 was used as the proton conducting membrane. Conductive carbon cloth was used as diffusion layers for the anode and cathode. Conductive plates with multiple flow channels were used as current collect plates for the anode and cathode.

The following conditions were used for open circuit measurements:

Operating Temperature: 80° C.

Methanol solution feed rate to the anode: 50 cm³/min

Air feed rate to the cathode: 2.5 Liter/min

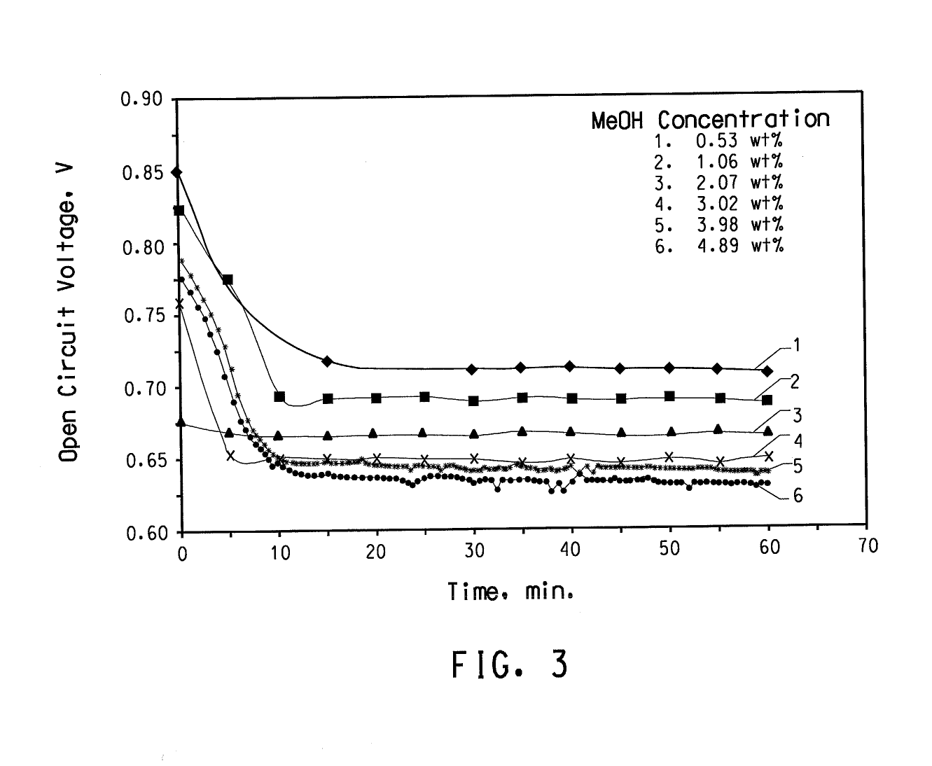

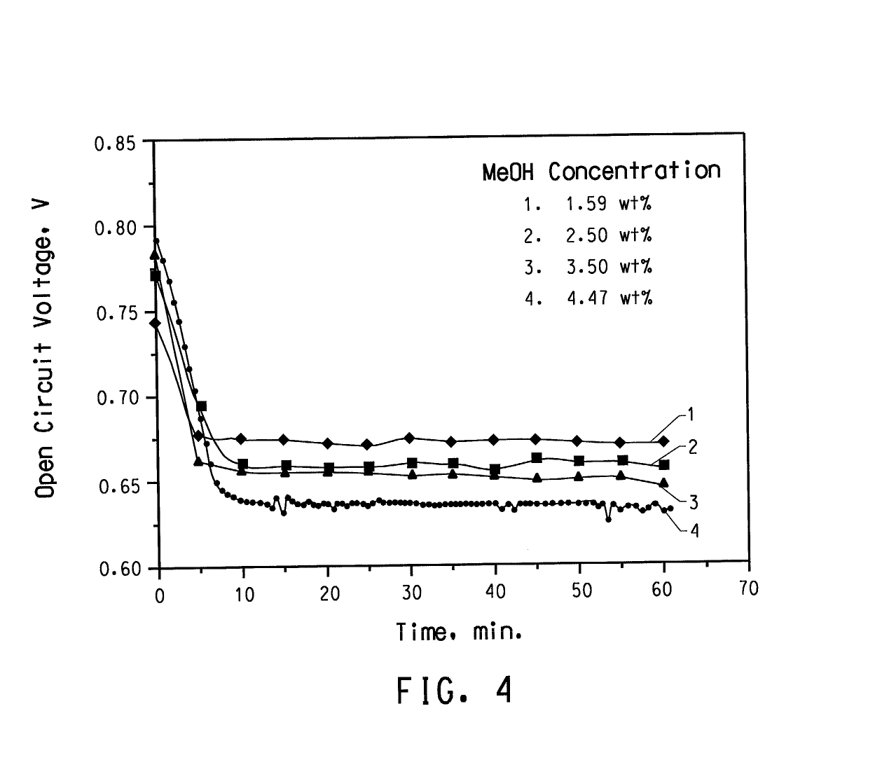

FIGS. 3 and 4 show plots of the open circuit voltage developed over time at different methanol concentrations. It took about 15 minutes for the fuel cell sensor to reach a steady state condition. After 15 minutes, the open circuit voltage remains constant with time. However, the steady state value of the open circuit voltage decreases with an increase in methanol concentration in the aqueous solution.

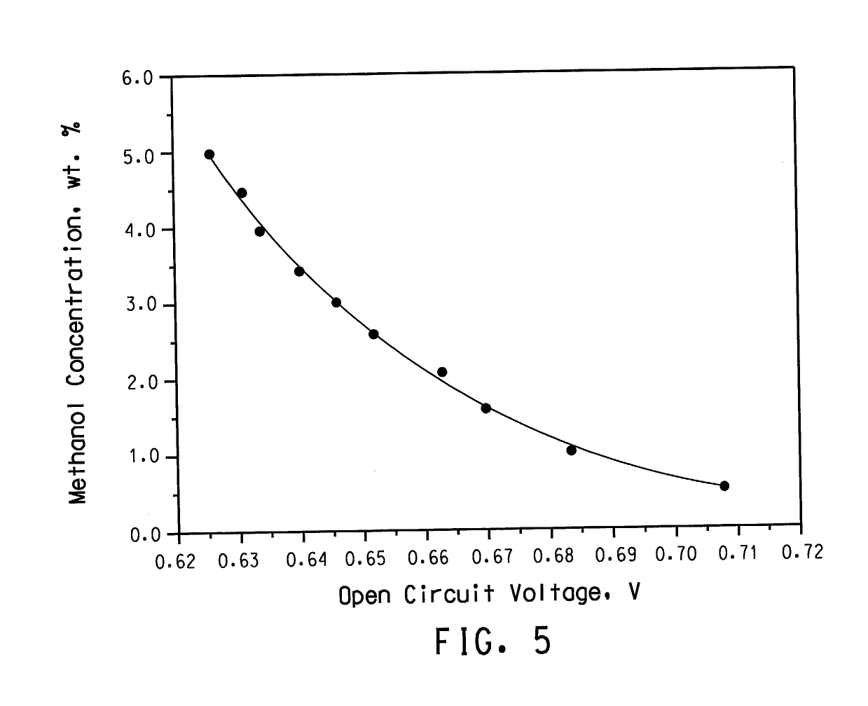

FIG. 5 illustrates the relationship between methaol concentration and open circuit voltage at 60 minutes. This plot can serve as a calibration curve to determine methanol concentration by measuring the open circuit voltage of the fuel cell sensor.

### Example 2

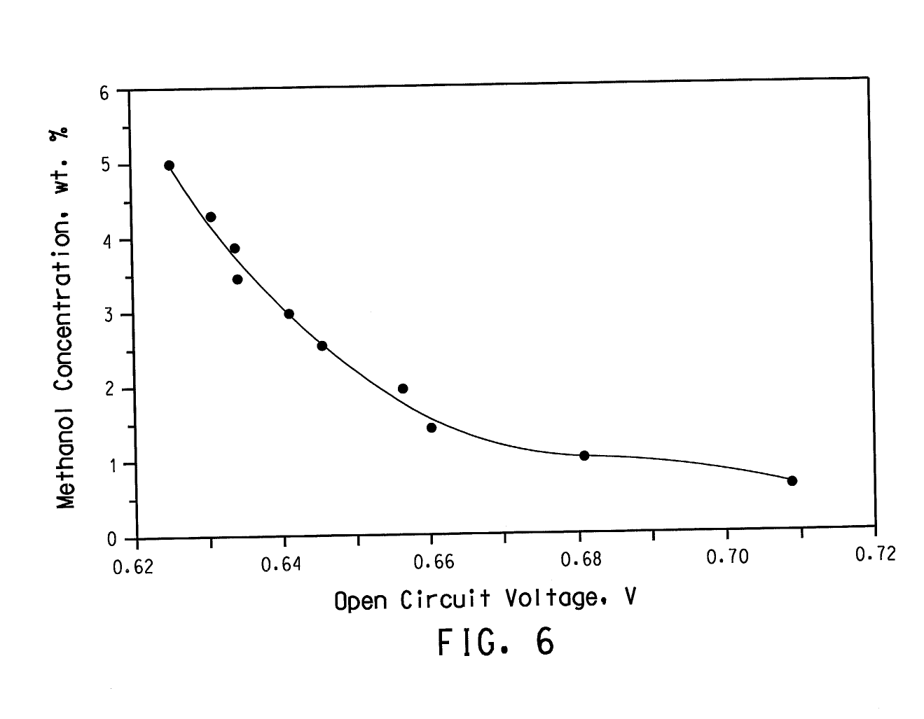

The fuel cell sensor used in this Example was the same as that used in Example 1. The operation conditions for the fuel cell sensor were also the same as in Example 1 except for fuel cell operating temperature. In this Example 2, the fuel cell sensor was operated using different methanol concentrations at 70° C. The open circuit voltage reached steady state at about 15 minutes, as was the case in Example 1. The relationship between the methanol concentration and the open circuit voltage is shown in FIG. 6.

### Example 3

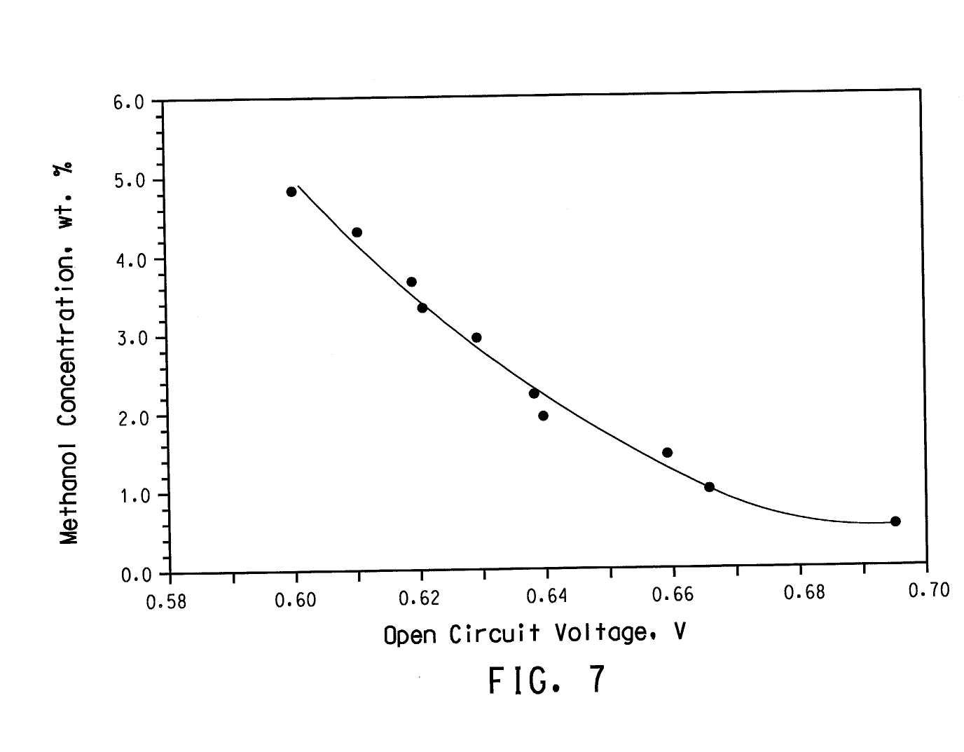

The fuel cell sensor used in this Example was also the same as in Example 1. In this Example, the fuel cell sensor was operated at 60° C. using different methanol concentrations. The other operating conditions were the same as those used in Example 1. The relationship between methanol concentration and open circuit voltage is shown in FIG. 7.

### Example 4

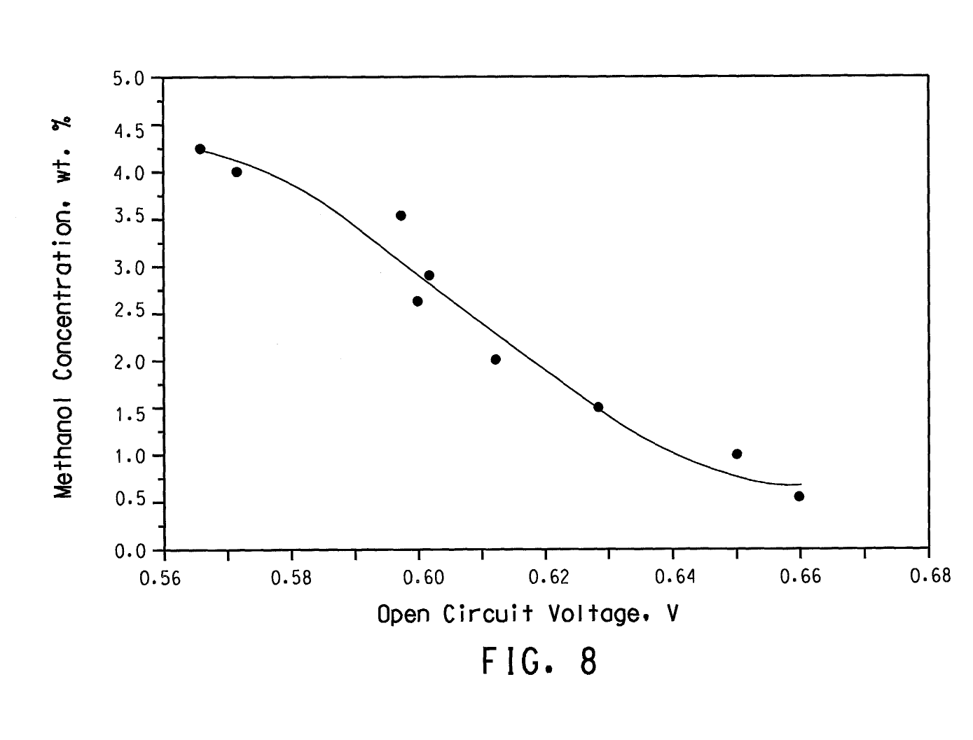

The fuel cell sensor used in this Example was also the same as in Example 1. In this Example, the fuel cell sensor was operated at 50° C. using different methanol concentrations. The other operating conditions were the same as those used in Example 1. The relationship between methanol concentration and open circuit voltage is shown in FIG. 8.

Therefore, FIGS. 5 through 8 show the calibration curves of methanol concentration as a function of open circuit voltage at different operating temperatures. In a DMFC system, by measuring the open circuit voltage of a fuel cell, one can obtain the methanol concentration of the aqueous solution fed to the anode chamber of the fuel cell.

The present invention is not limited to the application in a DMFC system. The method disclosed in this document can be used for other systems to measure the concentration of dilute methanol solutions.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. A method of measuring a concentration of a low molecular weight alcohol in an aqueous solution, the method comprising the steps of:
(a) providing a fuel cell sensor comprising:
i. an anode chamber for electrochemical oxidation of the alcohol comprising an anode flow field plate, an anode gas diffusion layer and an anode catalyst layer;
ii. a cathode chamber for electrochemical reduction of oxygen comprising a cathode flow field plate, a cathode gas diffusion layer and a cathode catalyst layer;
iii. a proton conducting membrane arranged between the anode and cathode chambers; and
iv. a voltmeter operatively connected to the anode and cathode;
(b) feeding the aqueous solution to the anode chamber and feeding air to the cathode chamber;
(c) operating the fuel cell sensor at an open circuit state;
(d) measuring the open circuit voltage across the anode and the cathode using the voltmeter; and
(e) determining the concentration of the low molecular weight alcohol using the open circuit voltage.

2. The method of claim 1 wherein the low molecular weight alcohol is methanol.

3. The method of claim 2 wherein the concentration of the methanol in the aqueous solution is in the range of from about 0.1 to about 25 weight %.

4. The method of claim 3 wherein the concentration of the methanol in the aqueous solution is in the range of from about 0.5 to about 15 weight %.

5. The method of claim 4 wherein the concentration of the methanol in the aqueous solution is in the range of from about 0.5 to about 10 weight %.

6. The method of claim 1 wherein the proton conducting membrane is solid polymer electrolyte.

7. The method of claim 1 further comprising the step of adding a high concentration low molecular weight alcohol solution to the aqueous solution when the concentration of the low molecular weight alcohol at the anode chamber is below a predetermined minimum level.

8. The method of claim 1 further comprising the step of adding water to the aqueous solution when the concentration of the low molecular weight alcohol at the anode chamber is above a predetermined maximum level.

9. The method of claim 1 wherein the fuel cell sensor comprises a single fuel cell.

10. The method of claim 1 wherein the fuel cell sensor comprises a series of fuel cells connected in a series or in parallel.

11. A device for measuring a concentration of a low molecular weight alcohol in an aqueous solution, the device comprising:
(a) an anode chamber for electrochemical oxidation of the low molecular weight alcohol comprising an anode flow field plate, an anode gas diffusion layer and an anode catalyst layer;
(b) a cathode chamber for electrochemical reduction of oxygen comprising a cathode flow field plate, a cathode gas diffusion layer and a cathode catalyst layer;
(c) a proton conducting membrane arranged between the anode and the cathode chambers;
(d) a voltmeter operatively connected to the anode and the cathode to measure voltage across the anode and the cathode; and
(e) an inlet for feeding the aqueous solution to the at least one anode chamber and an inlet for feeding air to the at least one cathode chamber such that an open circuit voltage is generated across the one anode and the one cathode due to oxidation at the cathode of crossover low molecular weight alcohol;
whereby the open circuit voltage is measured by the voltmeter and is dependent on the concentration of the low molecular weight alcohol in the aqueous solution.

12. The device of claim 11 wherein the proton conducting membrane is a solid polymer electrolyte.

13. The device of claim 11 wherein the low molecular weight alcohol is methanol.

14. The device of claim 13 adapted for measuring a concentration of methanol in the aqueous solution in a range from about 0.1 to about 25 weight %.

15. The device of claim 11 further comprising a first pump for pumping a high concentration solution of the low molecular weight alcohol to the aqueous solution when the concentration of the low molecular weight alcohol at the anode chamber is below a predetermined minimum level.

16. The method of claim 15 further comprising a second pump for pumping water to the aqueous solution when the concentration of the low molecular weight alcohol at the anode chamber is above a predetermined maximum level.
